(19) United States
(12) Patent Application Publication
(10) Pub. No.: US 2023/0259880 A1
(43) Pub. Date: Aug. 17, 2023

(54) SMART ERP IN SUPPLY CHAIN MANAGEMENT

(71) Applicant: Sustainable Outreach And Universal Leadership-SOUL Limited, Bhubaneshwar (IN)

(72) Inventors: Sasmita Samanta, Bhubaneshwar (IN); Pabitra Behera, Bhubaneshwar (IN)

(21) Appl. No.: 18/310,113

(22) Filed: May 1, 2023

(51) Int. Cl. G06Q 10/087; G06Q 30/0202

(52) U.S. Cl. CPC G06Q 10/087; G06Q 30/0202

(57) ABSTRACT

The present invention relates to a smart ERP (100) in supply chain management. The smart ERP (100) in supply chain management comprises a plurality of sensors, a data collection unit, a data analytics unit, an enterprise resource planning unit, a risk management unit, a server unit and a display unit. The enterprise resource planning unit comprises a inventory management unit, a demand forecasting unit, a procurement unit, a logistics and transportation unit, and a financial management unit. The risk management unit is configured to identify and mitigate risks throughout the supply chain. The server unit is configured to stores all of the data and manages the system's functionality. The display unit is configured to provide user interface. The smart ERP (100) in supply chain management provides real-time data analytics and insights, enabling companies to make better decisions and improve supply chain visibility.

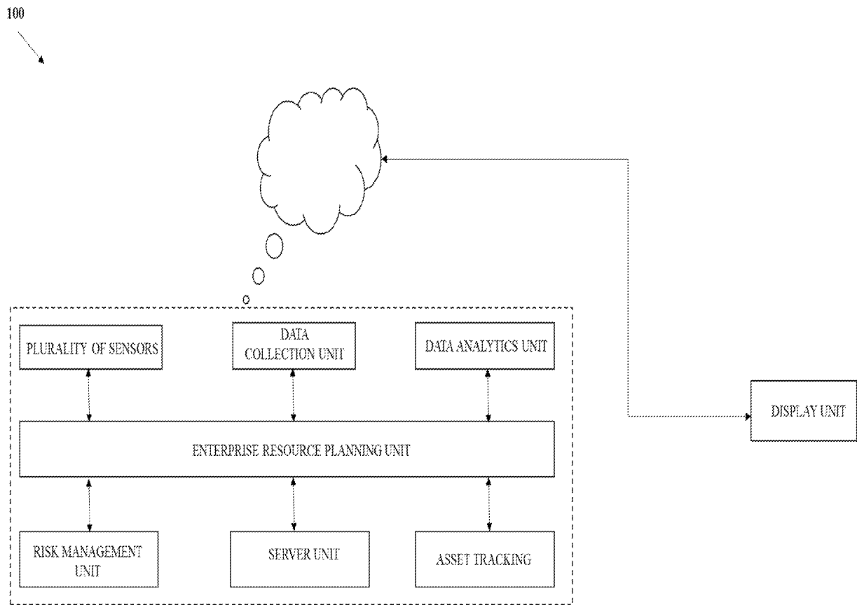

### FIELD

The present invention relates to the field of ERP systems, and more particularly to a smart ERP in supply chain management.

### BACKGROUND

Supply chain management (SCM) is the coordination and management of all the activities involved in the production and delivery of goods and services to customers. It involves managing the flow of materials, information, and money across the supply chain, from raw material suppliers to manufacturers, distributors, retailers, and ultimately, to the end customer. Effective supply chain management ensures that products are available at the right time, in the right quantity, and at the right price. It also involves managing relationships with suppliers, optimizing inventory levels, reducing costs, improving efficiency, and ensuring product quality and safety.

The conventional systems for supply chain management have been effective in managing the flow of goods and services through the supply chain, they also have some limitations and challenges. Here are some common problems associated with conventional systems for supply chain management: Many conventional systems for supply chain management are not designed to provide real-time visibility into the movement of goods through the supply chain. This can make it difficult for companies to respond quickly to changes in demand or supply chain disruptions. The Conventional supply chain management systems often rely on manual processes, such as email or phone calls, to communicate between different parties in the supply chain. This can lead to delays, errors, and miscommunication. The Conventional systems for supply chain management may not allow for easy data sharing between different parties in the supply chain. This can make it difficult to track inventory levels, forecast demand, and optimize supply chain operations. Many conventional systems for supply chain management are designed to manage a specific set of processes and may not be flexible enough to adapt to changing business needs or supply chain disruptions. Additionally, Implementation and maintenance conventional systems for supply chain management can be costly, particularly for smaller businesses. This can make it difficult for these companies to compete with larger competitors who have more resources.

Therefore, there remains a need in the art for a smart ERP in supply chain management that does not suffer from the above-mentioned deficiencies or at least provides a viable and effective solution.

### SUMMARY

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

An embodiment of the present invention provides a smart ERP in supply chain management. The smart ERP in supply chain management comprises a plurality of sensors, a data collection unit, a data analytics unit, an enterprise resource planning unit, a risk management unit, a server unit and a display unit. The plurality of sensors are configured to provide a real-time visibility into various aspects of the supply chain. The data collection unit are operationally connected with the plurality of sensors. The data collection unit are configured to collect data on inventory levels, transportation conditions, customer demand. The data analytics unit is operationally connected with the data collection unit. The data analytics unit is configured to identify patterns and trends, forecast demand, and optimize supply chain processes. The enterprise resource planning unit is operationally connected with the plurality of sensors, data collection unit, and data analytics unit. The enterprise resource planning unit comprises an inventory management unit, a demand forecasting unit, a procurement unit, a logistics and transportation unit, and a financial management unit. The inventory management unit is configured to track inventory levels in real-time, and automate inventory management processes such as ordering, receiving, and stocking. The demand forecasting unit is configured to forecast demand, enabling businesses to plan production schedules and inventory levels more accurately. The procurement unit is configured to streamline procurement processes by automating purchase orders, managing supplier information, and monitoring supplier performance. The logistics and transportation unit is configured to track, route and schedule shipments real-time. The financial management unit is configured to manage cash flow, monitor expenses, and optimize financial performance. The risk management unit is operationally connected with the data analytics unit and enterprise resource planning unit. The risk management unit is configured to identify and mitigate risks throughout the supply chain. The server unit is operationally connected with the risk management unit. The server unit is configured to stores all of the data and manages the system's functionality. The display unit is operationally connected with the plurality of sensors, data collection unit, data analytics unit, enterprise resource planning unit and risk management unit. The display unit is configured to provide user interface.

In accordance with an embodiment of the present invention, the enterprise resource planning unit configured to minimize stockouts, reduce excess inventory, and improve overall inventory accuracy.

In accordance with an embodiment of the present invention, the enterprise resource planning unit configured to ensure that the right products are in stock at the right time, reducing waste and improving customer satisfaction.

In accordance with an embodiment of the present invention, the enterprise resource planning unit configured to businesses are sourcing materials and components efficiently and cost-effectively.

In accordance with an embodiment of the present invention, the enterprise resource planning unit configured to reduce transportation costs, improve delivery times, and minimize delays and disruptions.

In accordance with an embodiment of the present invention, the enterprise resource planning unit configured to real-time financial data and insights, enabling businesses to manage cash flow, monitor expenses, and optimize financial performance.

Some of the objects of the present disclosure, which at least one embodiment herein satisfies, are as follows.

It is an object of the present disclosure to ameliorate one or more problems of the prior art or to at least provide a useful alternative.

An objective of the present disclosure is to provide a smart ERP in supply chain management.

An objective of the present disclosure is to provide a smart ERP in supply chain management to provide real-time data analytics and insights, enabling companies to make better decisions and improve supply chain visibility.

An objective of the present disclosure is to provide a smart ERP in supply chain management that can help companies to identify potential supply chain issues and opportunities, such as inventory shortages, production delays, and transportation disruptions.

An objective of the present disclosure is to provide a smart ERP in supply chain management that can track the movement of goods in real-time, enabling companies to optimize their logistics operations and reduce transportation costs.

An objective of the present disclosure is to provide a smart ERP in supply chain management provide secure and transparent supply chain management.

An objective of the present disclosure is to provide a smart ERP in supply chain management that can provide a permanent and tamper-proof record of the movement of goods, reducing the risk of fraud and counterfeiting.

### BRIEF DESCRIPTION OF THE DRAWINGS

So that the manner in which the above recited features of the present invention can be understood in detail, a more particular description of the invention, briefly summarized above, may have been referred to by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text Figure, with like reference numbers referring to like structures across the views, wherein

The Figure Illustrates a smart ERP in supply chain management, in accordance with an embodiment of the present invention.

### DETAILED DESCRIPTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention.

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

The Figure illustrates a smart ERP (100) in supply chain management, in accordance with an embodiment of the present invention. The smart ERP (100) in supply chain management comprises a plurality of sensors, a data collection unit, a data analytics unit, an enterprise resource planning unit, a risk management unit, a server unit and a display unit. The plurality of sensors are configured to provide a real-time visibility into various aspects of the supply chain. The data collection unit are operationally connected with the plurality of sensors. The data collection unit are configured to collect data on inventory levels, transportation conditions, customer demand. The data analytics unit is operationally connected with the data collection unit. The data analytics unit is configured to identify patterns and trends, forecast demand, and optimize supply chain processes. The enterprise resource planning unit is operationally connected with the plurality of sensors, data collection unit, and data analytics unit. The enterprise resource planning unit comprises a inventory management unit, a demand forecasting unit, a procurement unit, a logistics and transportation unit, and a financial management unit. The inventory management unit is configured to track inventory levels in real-time, and automate inventory management processes such as ordering, receiving, and stocking. The demand forecasting unit is configured to forecast demand, enabling businesses to plan production schedules and inventory levels more accurately. The procurement unit is configured to streamline procurement processes by automating purchase orders, managing supplier information, and monitoring supplier performance. The logistics and transportation unit is configured to track, route and schedule shipments real-time. The financial management unit is configured to manage cash flow, monitor expenses, and optimize financial performance. The risk management unit is operationally connected with the data analytics unit and enterprise resource planning unit. The risk management unit is configured to identify and mitigate risks throughout the supply chain. The server unit is operationally connected with the risk management unit. The server unit is configured to stores all of the data and manages the system's functionality. The display unit is operationally connected with the plurality of sensors, data collection unit, data analytics unit, enterprise resource planning unit and risk management unit. The display unit is configured to provide user interface.

In accordance with an embodiment of the present invention, the enterprise resource planning unit configured to minimize stockouts, reduce excess inventory, and improve overall inventory accuracy.

In accordance with an embodiment of the present invention, the enterprise resource planning unit configured to ensure that the right products are in stock at the right time, reducing waste and improving customer satisfaction.

In accordance with an embodiment of the present invention, the enterprise resource planning unit configured to businesses are sourcing materials and components efficiently and cost-effectively.

In accordance with an embodiment of the present invention, the enterprise resource planning unit configured to reduce transportation costs, improve delivery times, and minimize delays and disruptions.

In accordance with an embodiment of the present invention, the enterprise resource planning unit configured to real-time financial data and insights, enabling businesses to manage cash flow, monitor expenses, and optimize financial performance.

In accordance with an embodiment of the present invention, the plurality of sensors can be integrated into smart ERP (100)(Enterprise Resource Planning) in supply chain management to provide real-time data and insights about various aspects of the supply chain. The plurality of sensors can be used to track inventory levels in real-time, providing accurate and up-to-date information about stock levels and location. This information can be used to optimize inventory management processes and prevent stock outs. The plurality of sensors can be used to monitor product quality throughout the supply chain, from raw materials to finished products. This can help businesses identify quality issues early on, prevent product defects, and ensure that products meet customer expectations. The plurality of sensors can be used to track shipments in real-time, providing visibility into the location, temperature, and other conditions of goods in transit. This can help businesses optimize transportation routes, reduce delivery times, and minimize losses due to damage or spoilage. The plurality of sensors can be used to track the location and condition of assets such as equipment and vehicles, providing businesses with real-time visibility into asset utilization and maintenance needs. The plurality of sensors can be used to monitor environmental conditions such as temperature, humidity, and light levels. This can be particularly useful in industries such as food and beverage, pharmaceuticals, and healthcare, where environmental conditions can impact product quality and safety.

In accordance with an embodiment of the present invention, the enterprise resource planning unit is installed on a central server, which stores all of the data and manages the system's functionality. The server may be located on-site or in a cloud-based environment. The Clients are computers or other devices that connect to the server to access the enterprise resource planning unit. Clients can be located anywhere with an internet connection, allowing employees to access the system from remote locations. The network infrastructure is used to connect clients to the server. This may include local area networks (LANs), wide area networks (WANs), or virtual private networks (VPNs). The security measures are used to protect the system from unauthorized access, data breaches, and other security threats. This may include firewalls, antivirus software, and other security tools. The enterprise resource planning unit may also integrate with other systems, such as inventory management software, transportation management systems, and customer relationship management (CRM) software. This integration enables businesses to streamline processes and optimize their supply chain operations.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A smart ERP (100) in supply chain management, comprising:
a plurality of sensors configured to provide a real-time visibility into various aspects of the supply chain;
a data collection unit operationally connected with the plurality of sensors, configured to collect data on inventory levels, transportation conditions, customer demand;
a data analytics unit operationally connected with the data collection unit, configured to identify patterns and trends, forecast demand, and optimize supply chain processes;
a enterprise resource planning unit operationally connected with the plurality of sensors, data collection unit, and data analytics unit, comprises:
a inventory management unit configured to track inventory levels in real-time, and automate inventory management processes such as ordering, receiving, and stocking;
a demand forecasting unit configured to forecast demand, enabling businesses to plan production schedules and inventory levels more accurately;
a procurement unit configured to streamline procurement processes by automating purchase orders, managing supplier information, and monitoring supplier performance;
a logistics and transportation unit configured to track, route and schedule shipments real-time;
a financial management unit configured to manage cash flow, monitor expenses, and optimize financial performance;
a risk management unit operationally connected with the data analytics unit and enterprise resource planning unit, configured to identify and mitigate risks throughout the supply chain;
a server unit operationally connected with the risk management unit, configured to stores all of the data and manages the system's functionality;
a display unit operationally connected with the plurality of sensors, data collection unit, data analytics unit, enterprise resource planning unit and risk management unit, configured to provide user interface.

2. The smart ERP (100) in supply chain management of claim 1, wherein the enterprise resource planning unit configured to minimize stockouts, reduce excess inventory, and improve overall inventory accuracy.

3. The smart ERP (100) in supply chain management of claim 1, wherein the enterprise resource planning unit configured to ensure that the right products are in stock at the right time, reducing waste and improving customer satisfaction.

4. The smart ERP (100) in supply chain management of claim 1, wherein the enterprise resource planning unit configured to businesses are sourcing materials and components efficiently and cost-effectively

5. The smart ERP (100) in supply chain management of claim 1, wherein the enterprise resource planning unit configured to reduce transportation costs, improve delivery times, and minimize delays and disruptions.

6. The smart ERP (100) in supply chain management of claim 1, wherein the enterprise resource planning unit configured to real-time financial data and insights, enabling businesses to manage cash flow, monitor expenses, and optimize financial performance.
